(19) United States
(12) Patent Application Publication
(10) Pub. No.: US 2026/0115886 A1
(43) Pub. Date: Apr. 30, 2026

(54) MOBILE SUPPORT STAND SYSTEM FOR AUTOMOTIVE BUMPERS

(71) Applicant: US Auto Supply, Elgin, IL (US)

(72) Inventor: Brian James O'Reilly, Pingree Grove, IL (US)

(73) Assignee: US Auto Supply, Elgin, IL (US)

(21) Appl. No.: 18/934,021

(22) Filed: Oct. 31, 2024

(51) Int. Cl. B25H 1/00

(52) U.S. Cl. CPC B25H 1/0042

(57) ABSTRACT

A mobile painting stand system configured for supporting automotive bumpers comprising a mobile stand base, the mobile stand base being configured to move the mobile support stand system between locations, a vertical support shaft comprising a proximal end and a distal end, the distal end removably coupled to the mobile stand base, wherein a height of the vertical support shaft can be adjusted, a pivot head subassembly removably coupled to the proximal end of the vertical support shaft, at least one arm slidably coupled to the first end or the second end of the stem extension arm of the pivot head, at least one extension arm slidably coupled to the at least one arm, and at least one clipper arm movably coupled to the at least one extension arm, the at least one clipper arm configured to removably attach onto at least one automotive bumper.

### FIELD

The preferred implementation relates generally to automotive body painting and repair and particularly to mobile support stand systems for securely retaining and positioning an automobile bumper for painting and repair purposes.

### BACKGROUND

Painting and repair services are essential in many facilities engaged in activities such as auto body repair and auto restoration painting service. In these facilities, automotive bumpers are generally repaired and painted when removed from the vehicle. Due to the variabilities of the shapes of automotive bumpers, they are often required to be secured in a desirable position for a technician to carry out repair procedures. Additionally, it is often required that both the inside and outside surface of automotive bumpers be painted.

It is desirable to have a support stand which securely retains the entire bumper for painting and repair. It is also important for the support stand to be mobile and to be able expose various sides of the automotive bumper during the repair or painting operation Additionally it is desirable to have a support stand which allows the bumper, which comes in various shapes and sizes, to be adjustably positioned for optimum repair and painting of the bumper.

Presently available support stands fail to securely support automotive bumpers while providing easy access to the all the surfaces of the bumper. Presently available support stand systems are limited in their functionality in meeting the need for mobility (e.g., inferior casters with poor movement mechanics) of the support stand system across all surfaces and providing bumper movement/reorientation during the repair and painting process.

There remains an unresolved and unfulfilled need in the art for a more efficient mobile support stand system for securing and supporting automotive bumpers while also enabling the appropriate alignment/orientation for a successful painting and repair process.

### SUMMARY

Disclosed herein are approaches for addressing various of the problems and shortcomings of the state of the art, as identified above. More particularly, disclosed herein are mobile support stand systems for supporting automotive bumpers for repair and painting purposes.

According to a first aspect of the present disclosure, there is provided a mobile painting stand system configured for supporting automotive bumpers comprising a mobile stand base configured to move the mobile support stand system between locations, a vertical support shaft comprising a proximal end and a distal end, the distal end removably coupled to the mobile stand base, wherein a height of the vertical support shaft can be adjusted, a pivot head subassembly removably coupled to the proximal end of the vertical support shaft and comprising a pivot head configured to rotate about an axis perpendicular to the vertical support shaft and comprising a central stem comprising a proximal end and a distal end and a stem extension arm comprising a first end and a second end, the stem extension arm mechanically coupled to the distal end of the central stem, at least one arm slidably coupled to the first end or the second end of the stem extension arm, at least one extension arm slidably coupled to the at least one arm, at least one clipper arm movably coupled to the at least one extension arm and configured to removably attach onto at least one automotive bumper.

### BRIEF DESCRIPTION OF THE DRAWINGS

FIG. 1 shows a perspective view of an exemplary aspect of a mobile support stand system.

FIG. 2 shows a perspective view of an exemplary implementation of a pivot head according to an aspect of the mobile support stand system.

FIG. 3 shows a perspective view of an exemplary implementation of an arm according to an aspect of the mobile support stand system.

FIG. 4 shows a perspective view of an exemplary implementation of an extension arm according to an aspect of the mobile support stand system.

FIG. 5 shows a perspective view of an exemplary implementation of a clipper arm according to an aspect of the mobile support stand system.

FIG. 6A shows a perspective view of an exemplary implementation of a vertical support shaft according to an aspect of the mobile support stand system.

FIG. 6B shows an exploded view of an exemplary implementation of a vertical support shaft according to an aspect of the mobile support stand system.

FIG. 7 shows a perspective view of an exemplary implementation of a mobile stand base according to an aspect of the mobile support stand system.

### DETAILED DESCRIPTION

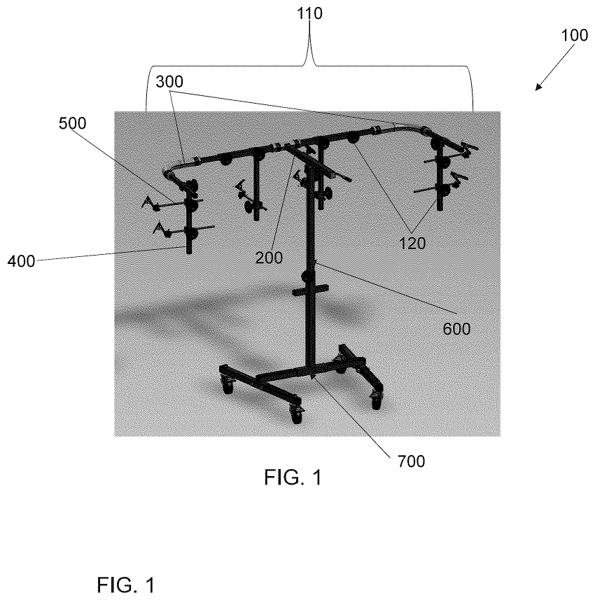

Referring to the drawings, FIG. 1 shows a perspective view of an exemplary aspect of a mobile support stand system 100. FIG. 1 also presents the primary structural components of the mobile support stand system 100. These include a pivot head subassembly 110 movably coupled to a vertical support shaft 600, and a mobile stand base 700 also coupled to the vertical support shaft 600. The pivot head subassembly 110 includes a pivot head 200 movably coupled to the vertical support shaft 600, at least one arm 300 coupled to the pivot head 200, at least one extension arm 400 slidably coupled to the at least one arm 300, and at least one clipper arm 500 slidably coupled to the at least one extension arm 400. The at least one clipper arm 500 is configured to removably couple to an automotive bumper and secure the automotive bumper for repair and painting processes. The mobile support stand system 100 can be configured to be length and width adjustable in its various components (as described in the paragraphs below) to be able to secure different sizes and shapes of automotive bumpers. The mobile stand base 700 is configured to confer mobility to the mobile support stand system 100 which could allow the repair and paint technician to move the mobile support stand system 100 across different floor surfaces. In some aspects, the mobile support stand system 100 can be made with square steel tubing. In some aspects, the square steel tubing used is a 16-gauge square steel tubing. In some aspects, the mobile support stand system 100 can include a surface coating, such as powder coating, to prevent surface degradation during chemical exposure (e.g., automotive bumper painting).

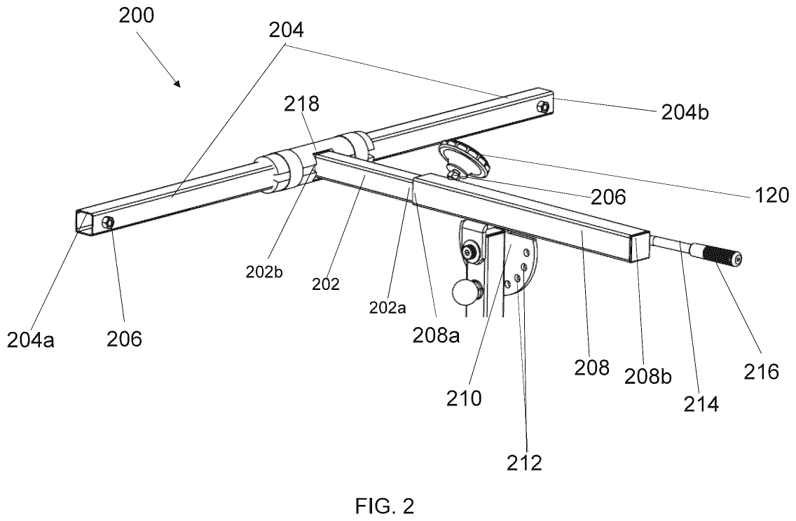

Referring to FIG. 2, a perspective view of an exemplary implementation of the pivot head 200 according to an aspect of the mobile support stand system 100 is shown. The pivot head 200 is movably coupled to the vertical support shaft 600. The pivot head 200 includes a central stem 202 comprising a proximal end 202a and a distal end 202b, and a stem extension arm 204 mechanically coupled to the distal end 202b of the central stem 202. In some implementations, such as the implementation presented in FIG. 2, the stem extension arm 204 can comprise a first end 204a and a second end 204b, each configured to receive the at least one arm 300. In some implementations, the pivot head 200 can further include a stem foam padding 218 disposed on the stem extension arm 204 and configured to protect the automotive bumpers during instances of falls and crashes when the mobile support stand system 100 is moved around.

In this implementation, the pivot head 200 further comprises a pivot arm 208 comprising a proximal end 208a and a distal end 208b. The distal end 208b of the pivot arm 208 is slidably coupled to the proximal end 202a of the central stem 202 such that the central stem 202 can slide along a length of the pivot arm 208. The distal end 208b of the pivot arm 208 further comprises a tightening nut 206 configured to secure the central stem 202 at a user-desired position along the length of the pivot arm 208. In some implementations, the tightening nut 206 can be coupled to a knob 120 configured to secure the central stem 202 at the user-desired position along the length of the pivot arm 208 when actuated.

The pivot head 200 further comprises a pivot plate 210 mechanically coupled to the pivot arm 208, and a handle 214 mechanically coupled to the pivot arm 208. In some implementations, the pivot head 200 is coupled to the vertical support shaft 600 via a bushing (not shown in FIG. 2) inserted through a bushing insertion point (not shown in FIG. 2) disposed on the pivot plate 210 such that the pivot head 200 is pivoted and is configured to move about the bushing. In some implementations, the handle 214 can include a grip 216 disposed on a distal end of the handle 214. In the implementation of the pivot head 200 shown in FIG. 2, the handle 214 can be configured to pivot the pivot head 200 about an axis perpendicular to vertical support shaft 600 at a plurality of pivot angles. In this implementation, each plurality angle of the plurality of angles at which the pivot head 200 can pivot to is determined by placement of a plunger 606 (explained in the paragraphs below) in each of the plurality of plunger insertion points 212 disposed on the pivot plate 210.

Referring to FIG. 2, the stem extension 204 comprises the first end 204a and the second end 204b, where each of the first end 204a and the second end 204b is configured to receive and slidably couple to the at least one arm 300, where the at least one arm 300 can slide along a length of the stem extension 204. In the implementation show in FIG. 2, each of the first end 204a and the second 204b further include a tightening nut 206 configured to secure the at least one arm 300 at a user-desired position along the length of the stem extension 204.

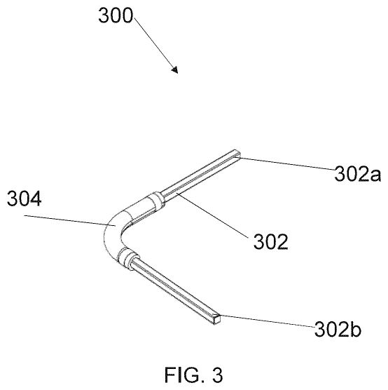

Referring to FIG. 3, a perspective view of an exemplary implementation of the at least one arm 300 according to an aspect of the mobile support stand system 100, is shown. As explained in the paragraphs above, the at least one arm 300 is configured to slide along the length of the stem extension 204. The at least one arm 300 comprises a proximal end 302a and a distal end 302b. The proximal end 302a of the at least one arm extension 300 is configured to slidably couple with the first end 204a or the second end 204b of the stem extension arm 204. The at least one arm 300 can be shaped to accommodate the shape of different automotive bumpers. In the implementation of FIG. 2, the at least one arm 300 is curve shaped to accommodate a shape of the automotive bumper. In some implementations, the at least one arm 300 can further include an arm foam padding 304 configured to further protect the automotive bumpers during instances of crashes when the mobile support stand system 100 is moved around.

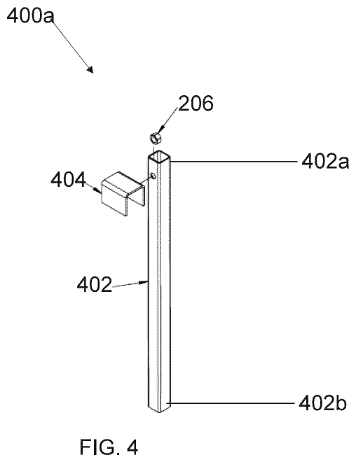

Referring to FIG. 4, a perspective views of an exemplary implementation of the at least one extension arm 400 according to an aspect of the mobile support stand system 100 is shown. The at least one extension arm 400 is configured to be slidably coupled to the at least one arm 300. In the implementation shown in FIG. 4, the at least one extension arm 400 is configured to be slidably coupled to the at least one arm 300 such that the at least one extension arm 400 is positioned perpendicularly relative to the at least one arm 300. The at least one extension arm 400 includes a core 402 with a proximal end 402a and a distal end 402b and a hook 404 disposed on the distal end 402a of the core 402. The hook 404 is configured to slidably coupled the at least extension arm 400 to the at least one arm 300. The hook 404 can be secured at a user-desired position along a length of the at least one arm 300 with another tightening nut 206. In some implementations, the tightening nut 206 can be coupled with a knob 120 (as shown in FIG. 1) to enable the user to tighten or loosen the tightening nut 206 and move the at least one extension arm 400 along the length of the at least one arm 300.

In the implementation shown in FIG. 4, the hook 404 can be U-shaped. In other implementations, the shape of the hook 404 can be a square or rectangular shape. In some aspects of the mobile support stand system 100, the mobile support stand system 100 can further comprise the at least one arm extension 400 slidably coupled to the stem extension arm 204 of the pivot head 200 as shown in FIG. 1.

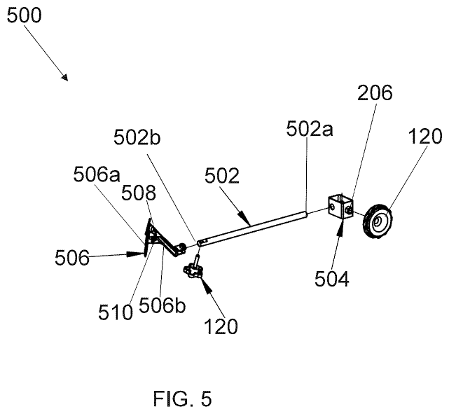

Referring to FIG. 5, a perspective view of an exemplary implementation of the at least one clipper arm 500 according to an aspect of the mobile support stand system 100 is shown. The at least one clipper arm 500 is configured to be slidably coupled to the at least one extension arm 400 and configured to secure the automotive bumpers. The at least one clipper arm 500 includes a clipper arm stem 502 comprising a proximal end 502a and a distal end 502b, a coupler 504 disposed on the distal end 502b of the clipper arm stem 502, and a clipper clamp 506 disposed on the proximal end 502a of the clipper arm stem. The distal end 402b of the core 402 of the at least one extension arm 400 is configured to receive the coupler 504 to slidably couple the at least one clipper arm 500 to the at least one extension arm 400. The coupler 504 is configured to rotate about and slide along a length of the at least one extension arm 400 to ensure freedom of movement to accommodate automotive bumpers of different shapes and size. In some implementations, the couple 505 further includes another tightening nut 206 configured to secure the coupler 504 at a user-desired position along the length of the at least one extension arm 400. In other implementations, the tightening nut 206 can be coupled to another knob 120 configured to secure the coupler 504 at the user-desired position along the length of the at least one extension arm 400 when actuated.

Referring to FIG. 5, the distal end 502b of the clipper arm stem 502 further comprises the clipper clamp 506 configured to removably attach to and secure the automotive bumpers during repair and painting processes. In the implementation shown in FIG. 5, the clipper clamp 506 comprises two arms 506a, b pivoted together with a bridge 508 such that the two arms 506a, b can clip onto the automotive bumper. In some implementations, the bridge 508 further includes a clip spring 510 configured to automatically return the two arms 506a, b to a clipped position after being forced apart temporarily to load an automotive bumper. In some implementations, the clipper clamp 506 is rotatably coupled to the distal end 502b of the clipper arm stem to provide rotational freedom to accommodate automotive bumpers of different sizes. In other implementations, the clipper clamp 506 is configured to rotate about an axis perpendicular to the clipper arm stem 502 and can secure at a user desired angle along its rotational axis via the knob 120 when actuated as shown in FIG. 5.

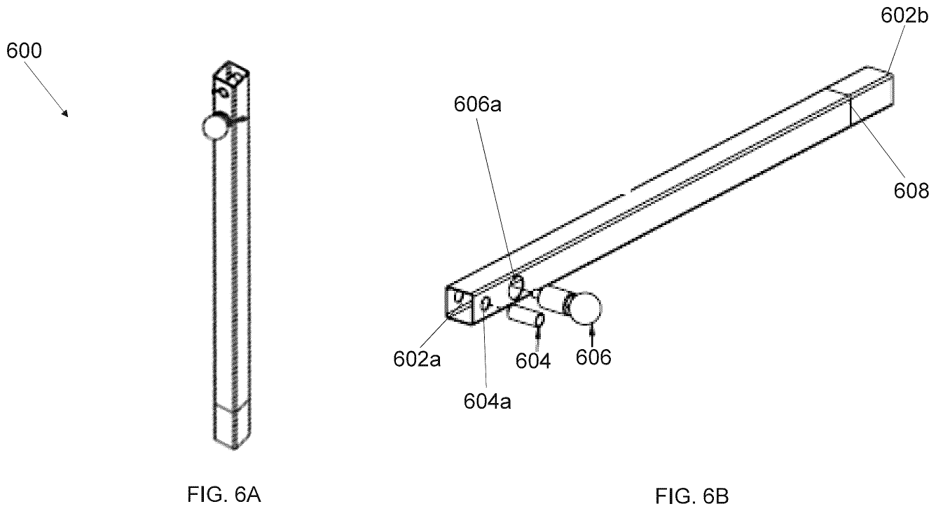

Referring to FIGS. 6A-6B, a perspective view and an exploded view of an exemplary implementation of the vertical support shaft 600 according to an aspect of the mobile support stand system 100, are shown respectively. In some implementations, the vertical support shaft 600 can be configured to be height adjustable. In some implementations, the vertical support shaft 600 can be height adjusted such that the mobile support stand system 100 comprises a height range between 40 inches and 62 inches tall. In the implementation of the vertical support shaft 600 shown in FIGS. 6A-6B, a distal end 602b of the vertical support shaft 600 is configured to couple to a vertical support shaft connector 708 (explained in the paragraphs below) to connect the vertical support shaft 600 to the mobile stand base 700. In this implementation, the vertical support shaft 600 comprises a stop plate 608 configured to limit a depth at which the vertical support shaft 600 can travel within the vertical support shaft connector 708.

In the implementation of the vertical support shaft 600 shown in FIGS. 6A-6B, the vertical support shaft further includes an insertion point 604a, which lines up with the bushing insertion point of the disposed on the pivot plate 210 of the pivot head 200, disposed proximally to a proximal end 602a of the vertical support shaft 600. The insertion point 604a (configured to line up with the bushing insertion point of the pivot plate 210) is configured to receive a bushing 604 and allow the pivot head 200 to rotate about the bushing 604. In this implementation, the vertical support shaft 600 further comprises a plunger point 606 (configured to line up with each of the plunger insertion points 212 of the pivot plate 210 of the pivot head 200) disposed proximally to the proximal end 602a of the vertical support shaft 600. The plunger point 606a is configured to receive a plunger 606 configured to secure the pivot head 200 at each plurality angle of the plurality of angles at which the pivot head 200 can pivot to. In some implementations, the plunger 606 can be a retractable plunger comprising a spring configured to automatically return the plunger 606 to an inserted position after being retracted temporarily when moving the pivot head 200 about the bushing 604.

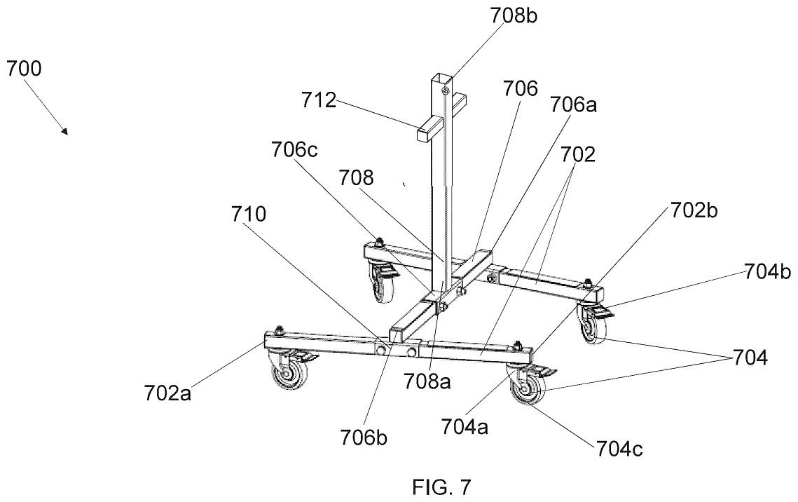

Referring to FIG. 7, a perspective view of the mobile stand base 700 according to an aspect of the mobile support stand system 100 is shown. The mobile stand base 700 includes at least one support leg 702 with two ends 702a, b and at least one lockable caster 704 disposed on each of the two ends 702a, b of the at least one support leg 704. The at least one support leg 702 can include more than one lockable caster 704. In some implementations of the mobile stand base 700, such as the implementation of FIG. 7, the mobile stand base 700 includes two support legs 702 connected by a bridge 706, where the two ends 706a, b of the bridge 706 are coupled to the two support legs 702 via brackets 710 disposed on the two ends 706a, b. The bridge brackets 710 can be coupled to the support legs 702 via bolts as shown in FIG. 7.

In the implementation of the mobile stand base 700 presented in FIG. 7, the mobile stand base 700 further comprises a vertical support shaft connector 708 disposed on the bridge 706 connecting the two support legs 702. A proximal end 708a of the vertical support shaft connector 708 comprises a bracket 706c configured for coupling to the bridge 706 via bolts. The distal end 708b is configured to removably couple to the vertical support shaft 600. In other implementations, the distal end 708 can be configured to be coupled to the vertical support shaft 600 via a screw (not shown in FIG. 7) disposed on the distal end 708 and configured to articulate with a corresponding thread disposed on the vertical support shaft 600. In some implementations, a depth of the vertical support shaft 600 that can be accommodated in the vertical support shaft connector 708 can be limited by the stop plate (not shown in FIGS. 6A-7) disposed in the vertical support shaft 600. In some implementations, the vertical support shaft connector 708 further comprises at least one storage protrusion 712 configured to couple to the at least one extension arm 400 or the at least one clipper arm 500.

In the implementation of the mobile stand base 700 presented in FIG. 7, the at least one lockable caster 704 comprises a swivel bracket 704a configured to allow rotation of the at least one lockable caster, a wheel brake 704b, and a rotatable wheel 704c contained within the swivel bracket 704a. The wheel brake 704b disposed on the swivel bracket 704a can be configured to restrict motion of the rotatable wheel 704c. When the wheel brake 704b is an engaged position, the wheel brake 704b can be configured to directly interface with the rotatable wheel 704c and restricts the motion of the rotatable wheel 704c. When the wheel brake 704c is a disengaged position, the wheel brake 704b can be configured to not interface with the rotatable wheel 704c and therefore not impede motion of the rotatable wheel 704c. In some implementations of the at least one lockable caster 704, the wheel brake 704b can be a foot brake comprising a foot pedal (not shown in the FIG. 7) and configured to switch the wheel brake 704b between the engaged and disengaged positions with the actuation of the foot pedal.

While the advantages and preferred implementations of the present invention have been described hereinbefore, those skilled in the art should be understood that the above are merely several illustrative implementations of the present invention without limiting the scope thereof, wherein various modifications, alterations or substitutions may be made to the specific components of the implementations without departing from the spirit and scope of the invention and its claims.

What is claimed is:

1. A mobile support stand system comprising:
a mobile stand base, the mobile stand base being configured to move the mobile support stand system between locations;
a vertical support shaft comprising a proximal end and a distal end, the distal end removably coupled to the mobile stand base, wherein a height of the vertical support shaft can be adjusted; and
a pivot head subassembly removably coupled to the proximal end of the vertical support shaft, the pivot head subassembly comprising:
a pivot head configured to rotate about an axis perpendicular to the vertical support shaft, the pivot head comprising:
a central stem comprising a proximal end and a distal end; and
a stem extension arm comprising a first end and a second end, the stem extension arm mechanically coupled to the distal end of the central stem;
at least one arm slidably coupled to the first end or the second end of the stem extension arm;
at least one extension arm slidably coupled to the at least one arm; and
at least one clipper arm movably coupled to the at least one extension arm, the at least one clipper arm configured to removably attach onto at least one automotive bumper.

2. The mobile support stand system of claim 1, wherein the pivot head further comprises:
a pivot arm slidably coupled to the proximal end of the central stem of the pivot head; and
a pivot plate mechanically coupled to the pivot arm, the pivot plate configured to rotatably couple the pivot head to the vertical support shaft.

3. The mobile support stand system of claim 2, wherein the pivot plate further comprises:
a plurality of plunger insertion points, wherein each of the plunger insertion points is configured to receive a plunger disposed on the vertical support shaft; and
a bushing insertion point, wherein the bushing insertion point is configured to receive a bushing and rotatably couple the pivot plate to the vertical support shaft.

4. The mobile support stand system of claim 3, wherein the pivot head further comprises a handle configured to allow a user to rotate the pivot plate about the bushing to each of the plurality of plunger insertion points.

5. The mobile support stand system of claim 4, wherein the handle comprises a grip mechanically coupled to the handle.

6. The mobile support stand system of claim 1, wherein the central stem of the pivot head further comprises a stem foam padding.

7. The mobile support stand system of claim 1, wherein the at least one arm comprises:
a proximal end configured to slidably couple to one of the first end or the second end of the stem extension arm; and
a distal end configured to receive the at least one extension arm.

8. The mobile support stand system of claim 7, wherein the at least one extension arm further comprises:
a core comprising a proximal end and a distal end;
a hook disposed on the proximal end of the core, the hook configured to slidably couple the at least one extension arm to the at least one arm.

9. The mobile support stand system of claim 8, where the at least one extension arm configured to be oriented perpendicular to the at least one arm.

10. The mobile support stand system of claim 8, wherein the at least one clipper arm comprises:
a clipper arm stem comprising a proximal end and a distal end;
a coupler disposed on the distal end of the clipper arm stem, the coupler configured to movably couple the at least one clipped arm to the at least one arm extension; and
a clipper clamp disposed on the proximal end of the clipper arm stem, the clipper clamp comprising two arms pivoted together with a bridge.

11. The mobile support stand system of claim 10, wherein the clipper clamp further comprises a clip spring disposed between the two arms, the clip spring configured to automatically return the two arms to a clipped position after being temporarily forced apart.

12. The mobile support stand system of claim 10, wherein the clipper clamp is configured to rotate about an axis perpendicular to the clipper arm stem.

13. The mobile support stand system of claim 10, wherein the clipper clamp further comprises a knob configured to secure the clipper clamp at a user-desired angle when actuated.

14. The mobile support stand system of claim 1, wherein the mobile stand base comprises:
at least one support leg comprising two ends; and
at least one lockable caster disposed on each of the two ends of the at least one support leg.

15. The mobile support stand system of claim 14, wherein the at least one lockable caster comprises:
a swivel bracket configured to allow rotation of the at least one lockable caster;
a rotatable wheel contained with the swivel bracket; and
a wheel brake disposed on the swivel bracket and configured to restrict motion of the rotatable wheel in an engaged position.

16. The mobile support stand system of claim 14, wherein the at least one support leg comprises two support legs connected by a bridge disposed between both support legs, wherein each of the support legs comprises at least one lockable caster.

17. The mobile support stand system of claim 16, wherein the mobile stand base further comprises a vertical support shaft connector disposed on the bridge and configured to removably couple to the distal end of the vertical support shaft

18. The mobile support stand system of claim 17, wherein the vertical support shaft connector comprises at least one storage protrusion configured to secure the at least extension are or the at least one clipper arm.

19. The mobile support stand system of claim 3, wherein the vertical support shaft further comprises:
an insertion point disposed proximally to the proximal end of the vertical support shaft, the insertion point configured to:
line up with the bushing insertion point of the pivot head; and
receive the bushing; and
a plunger point disposed proximally to the proximal end of the vertical support shaft, the plunger point configured to:
line up with the each of the plurality of plunger insertion points disposed on the pivot plate; and
receive the plunger configured to lock the pivot head at an angle corresponding to the each of the plurality of plunger insertion point.

20. The mobile support stand system of claim 19, wherein the plunger is a retractable plunger comprising a spring configured to automatically return the plunger to an inserted position when the plunger is retracted.
